(19) United States
(12) Patent Application Publication
(10) Pub. No.: US 2005/0156803 A1
(43) Pub. Date: Jul. 21, 2005

(54) Antenna with one or more holes

(76) Inventors: Jordi Soler Castany, San Cugat del Valles (Barcelona) (ES); Carles Puente Baliarda, San Cugat del Valles (Barcelona) (ES)

Correspondence Address: Joseph M. Sauer;Jones Day, North Point, 901 Lakeside Avenue, Cleveland, OH, 44114, US

(21) Appl. No.: 11/036,509

(22) Filed: Jan. 12, 2005

Related U.S. Application Data
(63) Continuation of application No. PCT/EP02/07836, filed on Jul. 15, 2002.

(51) Int. Cl. H01Q 13/10

(52) U.S. Cl. 343/770; 343/810

(57) ABSTRACT

The invention refers to a new type of multihole antenna which is mainly suitable for mobile communications or in general to any other application where the integration of telecom systems or applications in a single antenna is important. The antenna consists of a radiating element which at least includes one hole. By means of this configuration, the antenna provides a broadband and multiband performance, and hence it features a similar behaviour through different frequency bands. Also, the antenna features a smaller size with respect to other prior art antennas operating at the same frequency.

### OBJECT OF THE INVENTION

The present invention relates to a novel multihole antenna which operates simultaneously at several frequencies with an improved impedance match. Also, the antenna features a smaller size with respect to other prior art antennas operating at the same frequency.

The radiating element of the novel multihole antenna consists of an antenna shaped by means of a polygonal, space-filling, loaded or multilevel shape, which at least includes one hole in the radiating antenna surface.

The invention refers to a new type of multihole antenna which is mainly suitable for mobile communications or in general to any other application where the integration of telecom systems or applications in a single antenna is important.

### BACKGROUND OF THE INVENTION

The growth of the telecommunication sector, and in particular, the expansion of personal mobile communication systems are driving the engineering efforts to develop multiservice (multifrequency) and compact systems which require multifrequency and small antennas. Therefore, the use of a multisystem small antenna with a multiband and/or wideband performance, which provides coverage of the maximum number of services, is nowadays of notable interest since it permits telecom operators to reduce their costs and to minimize the environmental impact.

Most of the multiband reported antenna solutions use one or more radiators or branches for each band or service. An example is found in U.S. Ser. No. 09/129,176 entitled “Multiple band, multiple branch antenna for mobile phone”.

One of the alternatives which can be of special interest when looking for antennas with a multiband and/or small size performance are multilevel antennas, Patent publication WO0122528 entitled “Multilevel Antennas”, miniature space-filling antennas, Patent publication WO0154225 entitled “Space-filling miniature antennas”, and loaded antennas, Patent application PCT/EP01/11914 entitled “Loaded Antenna”.

N. P. Agrawall (“New wideband monopole antennas”, Antennas and Propagation Society International Symposium, 1997, IEEE, vol. 1, pp. 248-251) presents the results for a set of solid planar polygonal monopole antennas, which are not the case of the present invention.

### SUMMARY OF THE INVENTION

The key point of the invention is the shape of the radiating element which includes a set of holes practised in the radiating element. According to the present invention the antenna is a monopole or a dipole which includes at least one hole. Also, the antenna can include different holes with different shapes and sizes in a radiating element shaped by means of a polygonal, multilevel or loaded structure.

Due to the addition of the holes in the radiating element, the antenna can feature a multifrequency behaviour with a smaller size with respect to other prior art antennas operating at the same frequency. For the mentioned multifrequency behaviour, said hole in a monopole or dipole antenna features an area of at least a 20% of the area included inside the external perimeter of the radiating element of said antenna.

The novel monopole or dipole includes a radiating element of a conducting or superconducting material with at least one hole, wherein the hole can be filled with a dielectric or partially filled by a conducting or superconducting material different from the conductor used for the radiating element.

In the novel antenna, the holes, or a portion of them, can be shaped with a geometry chosen form the set: multilevel, loaded, space-filling or polygonal structures. These geometries being understood as described in the previously identified patents.

The main advantage of this novel multihole antenna is two-folded:
The antenna features a multifrequency behaviour
The antenna can be operated at a lower frequency than most of the prior art antennas

### BRIEF DESCRIPTION OF THE DRAWINGS

FIG. 1 shows three different antennas including one hole; those are, a circular, an elliptical and a rectangular antenna. All the cases are polygonal shapes, including the circles and the ellipses as they can be considered polygonal structures with a large number of sides. Cases 1 to 3 show an antenna where the radiating element is a circle including one hole, wherein the size of the hole increases from cases 1 to 3, being the biggest one (3b) and the smallest one case (1a). Also, cases 1 to 3 includes a hole with a circular shape. Case 4 and 5 describe an elliptical monopole with an elliptical hole. In case (4b) the hole is not symmetrically located with respect to the vertical axis of the radiating element. Case 6 shows a rectangular monopole including one rectangular hole. In all cases in FIG. 1 the area of the hole is at least a 20% of the area included in the external perimeter of the radiating element.

FIG. 2 shows three different types of multihole antenna. Case 7 shows a radiating element with a circular shape with two identical circular holes (7a) and with a third bigger hole (7b). The antennas in cases 8 and 9 are multihole antennas where the hole is shaped as a curve, said curve intersecting itself at a point. Cases 10 and 11 shows a polygonal radiating element with one and three holes, respectively, shaped using a multilevel structure.

In FIG. 3, case 12 shows a radiating element with a triangular shape which includes one hole shaped by means of a space-filling curve (12b). Case 13 shows a multihole antenna with a circular hole, wherein the hole intersects the perimeter of the radiating element at a distance to the feeding point longer than three quarters of the external perimeter of the radiating element. Case 14 describes a radiating element (14a) composed by a rectangular and a circular shape, which includes two holes; those are, a circular-shaped hole (14b) and a hole shaped by means a multilevel structure (14c). Case 15 shows another radiating element with a hole with a circular shape (15b).

FIG. 4, case 16, shows a loaded radiating element (16a) including two rectangular holes (16b).

FIG. 5 shows two particular cases of multihole antenna. They consist of a monopole comprising a conducting or superconducting ground plane with an opening to allocate a coaxial cable (18) with its outer conductor connected to said ground plane and the inner conductor connected to the multihole radiating element. The radiating element can be optionally placed over a supporting dielectric (20).

FIG. 6 shows a multihole antenna consisting of a dipole wherein each of the two arms includes one hole. The lines (21) indicate the input terminals points. The two drawings display different configurations of the same basic dipole; in the lower drawing the radiating element is supported by a dielectric substrate (20).

FIG. 7 shows an aperture antenna, wherein a multihole structure is practiced as an aperture antenna (3). The aperture is practiced on a conducting or superconducting structure (23).

FIG. 8 shows an antenna array (24) including multihole radiating elements (17).

### DETAILED DESCRIPTION OF SOME PREFERRED EMBODIMENTS

A preferred embodiment of the multihole antenna is a monopole configuration as shown in FIG. 5. A handheld telephone case, or even a part of the metallic structure of a car or train can act as such a ground counterpoise. The ground and the monopole arm (17) (here a particular embodiment of the arm is represented, but any of the mentioned multihole antenna structures could be taken instead) are excited as usual in prior art monopole by means of, for instance, a transmission line (18). Said transmission line is formed by two conductors, a first conductor is connected to a point of the conducting or superconducting multihole structure and the second conductor is connected to the ground plane or to a ground counterpoise. In FIG. 5, a coaxial cable (18) has been taken as a particular case of transmission line, but it is clear to any skilled in the art that other transmission lines (such as for instance a microstrip arm) could be used to excite the monopole. Optionally, and following the scheme just described, the multihole monopole can be printed, etched or attached, for instance, over a dielectric substrate (20).

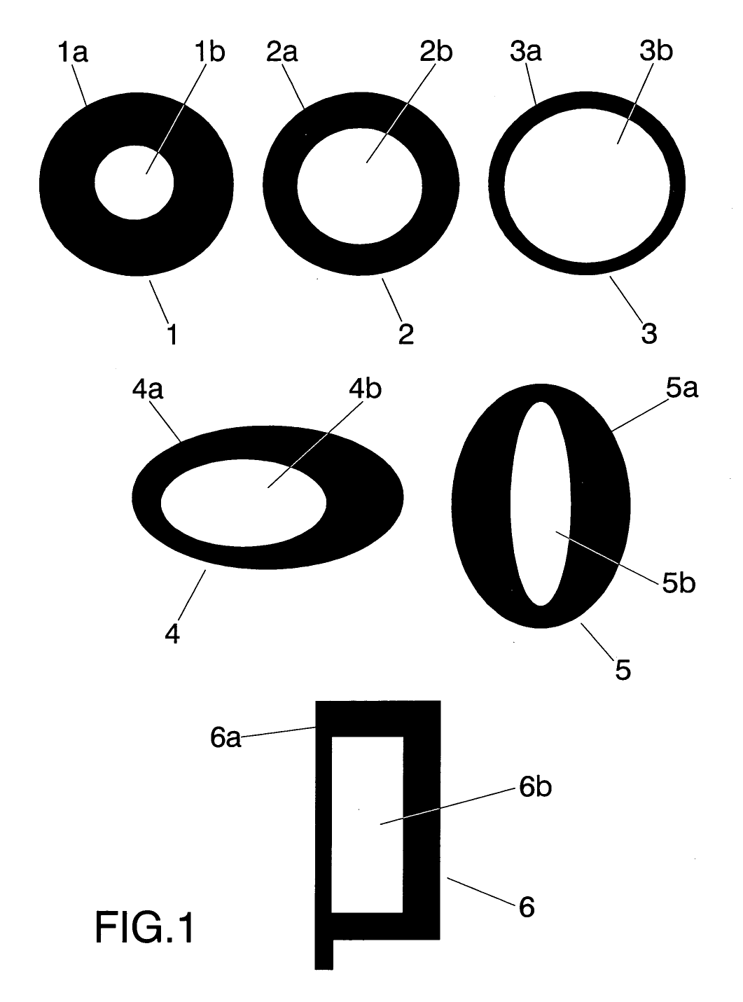

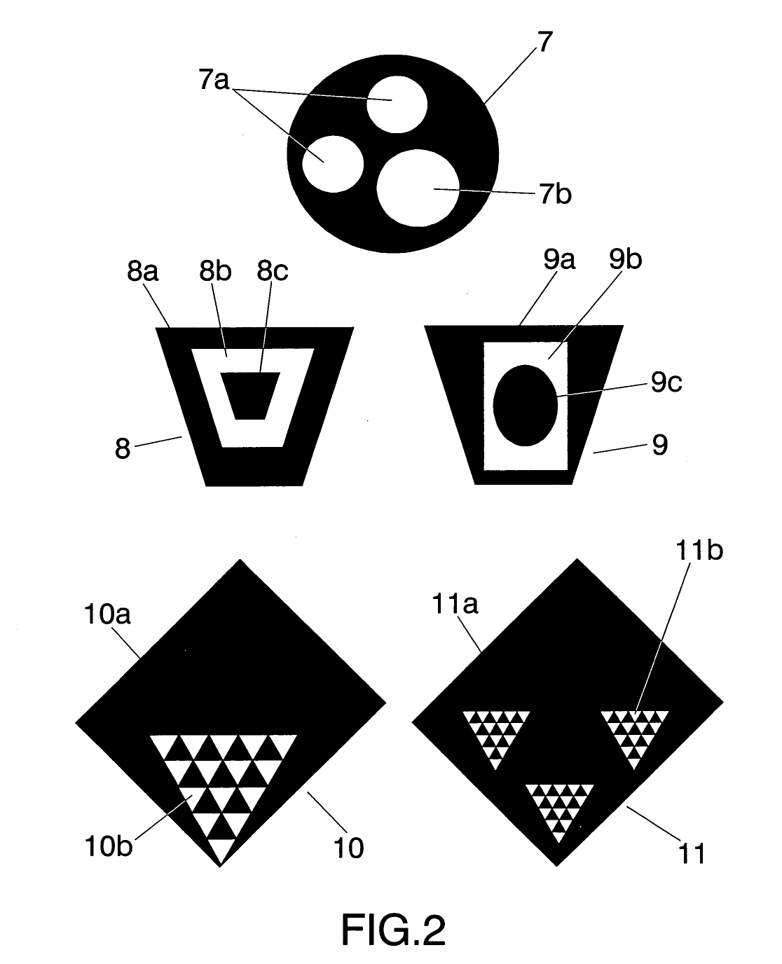

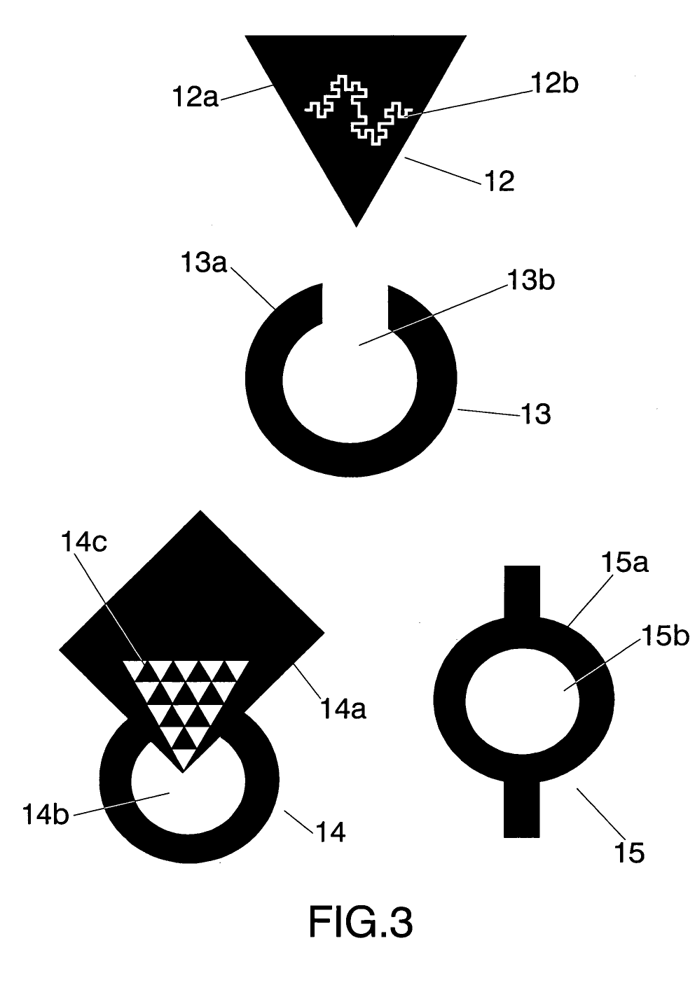

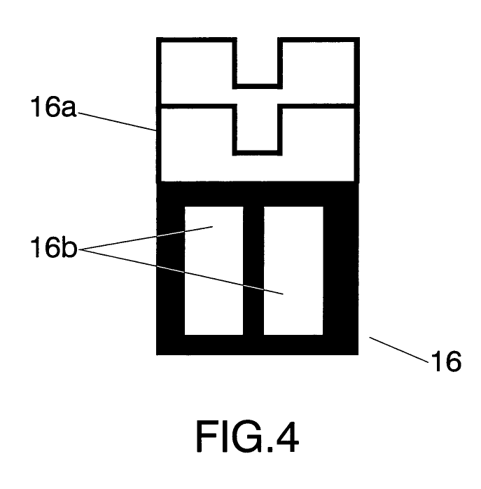

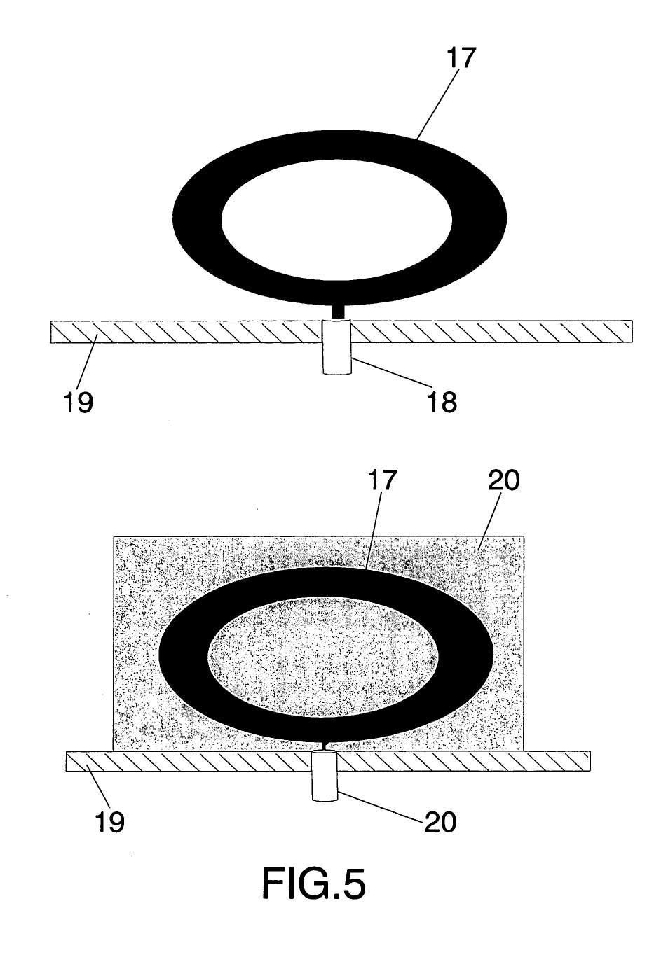

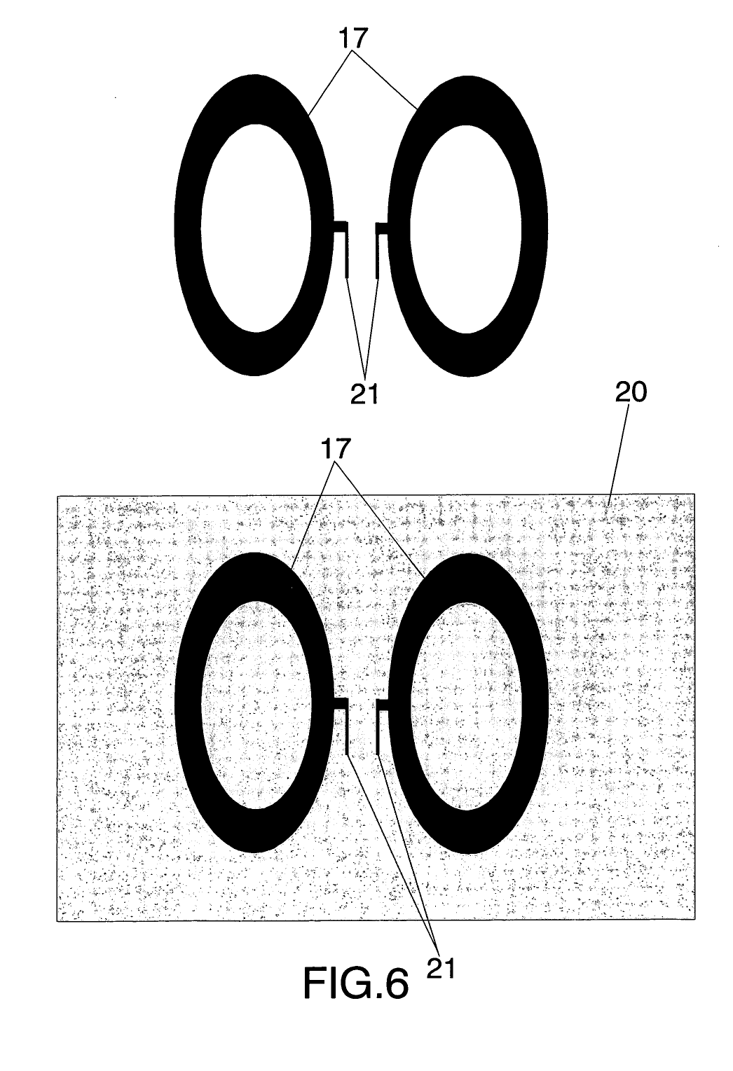

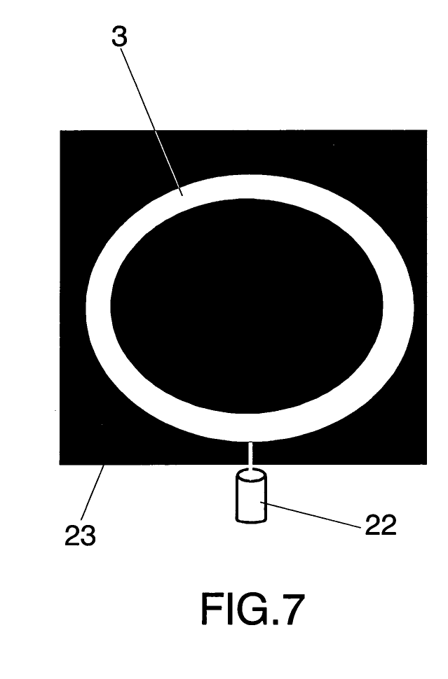

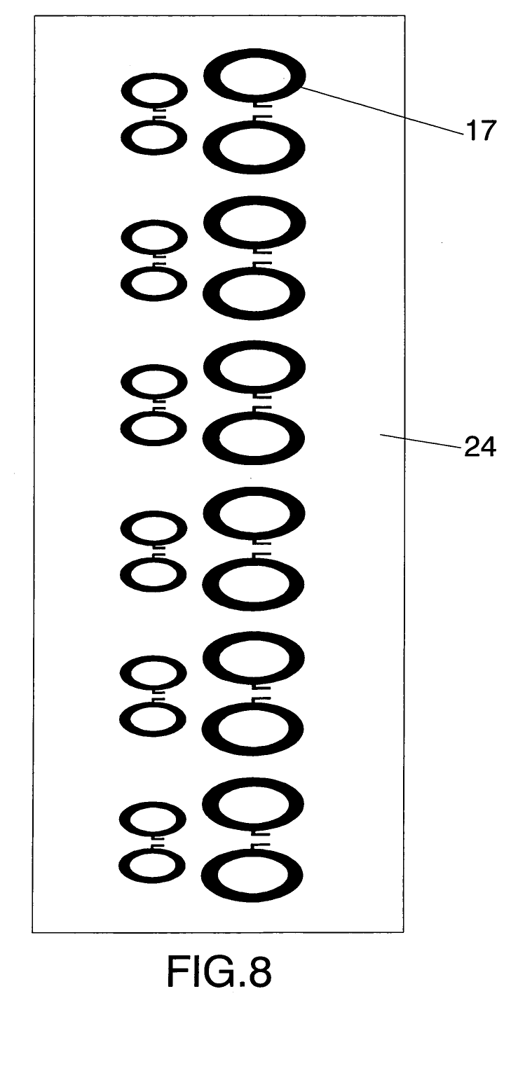

FIG. 6 describes another preferred embodiment of the invention. A two-arm antenna dipole is constructed comprising two conducting or superconducting parts, each part being a multihole structure. For the sake of clarity but without loss of generality, a particular case of the multihole antenna (17) has been chosen here; obviously, other structures, as for instance, those described in FIG. 1 could be used instead. In this particular case, two points (21) on the perimeter of each arm can are taken as the input part of the dipole structure. In other embodiments, other point can be takes as the input terminals. The terminals (21) have been drawn as conducting or superconducting wires, but as it is clear to those skilled in the art, such terminals could be shaped following any other pattern as long as they are kept small in terms of the operating wavelength. The skilled in the art will notice that, the arms of the dipoles can be rotated and folded in different ways to finely modify the input impedance or the radiation properties of the antenna, such as, for instance, polarization.

Another preferred embodiment of a multihole dipole antenna is also shown in FIG. 6 where the multihole arms are printed over a dielectric substrate (20); this method is particularly convenient in terms of cost and mechanical robustness when the shape of the radiating element contains a high number of polygons, as happens with multilevel structures. Any of the well-known printed circuit fabrication techniques can be applied to pattern the notched-fed structure over the dielectric substrate. Said dielectric substrate can be, for instance, a glass-fibre board, a teflon based substrate (such as Cuclad®) or other standard radiofrequency and microwave substrates (as for instance Rogers 4003® or Kapton®). The dielectric substrate can be, for instance, a portion of a window glass if the antenna is to be mounted in a motor vehicle such as a car, a train or an airplane, to transmit or receive radio, TV, cellular telephone (GSM900, GSM1800, UMTS) or other communication services electromagnetic waves. Of course, a balun network can be connected or integrated in the input terminals of the dipole to balance the current distribution among the two dipole arms.

Another preferred embodiment of the multihole antenna is an aperture configuration as shown in FIG. 7. In this figure the multihole elliptical structure (3) forms a slot or gap impressed over a conducting or superconducting sheet (23). Such sheet can be, for instance, a sheet over a dielectric substrate in a printed circuit board configuration, a transparent conductive film such as those deposited over a glass window to protect the interior of a car from heating infrared radiation, or can even be apart of the metallic structure of a handheld telephone, a car, train, boat or airplane. The feeding scheme can be any of the well known in conventional slot antenna and it does not become an essential part of the present invention. In the illustration in FIG. 7, a coaxial cable (22) has been used to feed the antenna, with one of the conductors connected to one side of the conducting sheet and the other connected at the other side of the sheet across the slot. A microstrip line could be used, for instance, instead of a coaxial cable.

FIG. 8 describes another preferred embodiment. It consist of an antenna array (24) which includes at least one multihole dipole antenna (17).

1.- An antenna comprising a radiating element defining an external perimeter characterised in that said radiating element includes at least one hole, wherein said hole has an area of at least a 20% of the area included inside the external perimeter of the radiating element of said antenna, wherein
the perimeter of the radiating element is shaped as a polygonal element comprising at least four sides, and wherein
the perimeter of at least one of the holes is shaped as a polygon with three or more sides,
the antenna configuration being chosen from the following set: a monopole antenna, a dipole antenna, an aperture antenna or a slot antenna.

2.- An antenna according to claim 1 characterised in that the radiating element is a conducting or superconducting body, said body including at least one hole which is filled with a dielectric material.

3.- An antenna according to claim 1 characterised in that the radiating element is a conducting or superconducting body, said body including at least one hole which is partially filled by a conducting or superconducting material.

4.- An antenna according to claim 1 or claim 2 characterised in that the perimeter of the radiating element is shaped with a geometry selected from the group: square, rectangular, trapezoidal, pentagonal, hexagonal, heptagonal, octagonal, circular or elliptical.

5.- An antenna according to any one of the preceding claims characterised in that the perimeter of at least one of the holes is shaped with a geometry selected from the group: triangular, square, rectangular, trapezoidal, pentagonal, hexagonal, heptagonal, octagonal, circular or elliptical.

6.- An antenna according to claim 1, 2, 3, 4 or 5 characterised in that the perimeter of the radiating element is circular or elliptical.

7.- An antenna according to claim 1, 2, 3, 4 or claim 5 characterised in that the perimeter of the radiating element is circular and the perimeter of at least one of the holes is hexagonal.

8.- An antenna according to claim 6 characterised in that the perimeter of at least one of the holes is circular or elliptical.

9.- An antenna according to claim 4 or claim 5 characterised in that the perimeter of the radiating element comprises at least two more sides than the perimeter of the hole with the least number of sides.

10.- An antenna according to claim 4 or claim 5 characterised in that the perimeter of the radiating element or the perimeter of at least one of the holes, comprises five or more sides.

11.- An antenna according to any one of the preceding claims characterised in that at least one of the holes is not symmetrically aligned with respect to the vertical axis of the radiating element.

12.- An antenna according to any of the preceding claims characterised in that a portion of said antenna is a multilevel structure.

13.- An antenna according to claim 12 characterised in that at least a portion of at least one of the holes is a multilevel structure.

14.- An antenna according to any one of the preceding claims characterised in that a portion of said antenna is a loading structure.

15- An antenna according to any one of the preceding claims characterised in that the radiating element comprises at least two holes wherein at least one of the holes has different shape than the other ones.

16.- An antenna according to any one of the preceding claims characterised in that the radiating element comprises at least two holes wherein at least one of the holes has different size than the other ones.

17.- An antenna according to claims 15, characterised in that the antenna has a polygonal perimeter with more than four sides, a first larger hole symetrically placed in the center of the perimeter, and a set of smaller holes with the same area radially arranged around said first larger hole.

18.- An antenna according to any of the preceding claims characterised in that at least the perimeter of at least one hole is a curve composed by a minimum of two segments and a maximum of nine segments which are connected in such a way that each segment forms an angle with their neighbours, i.e., no pair of adjacent segments define a larger straight segment.

19.- An antenna according to any of the preceding claims characterised in that at least part of the perimeter of at least one hole is shaped by means of a space-filling curve.

20.- An antenna according to any of the preceding claims characterised in that at least one of the holes intersects the perimeter of the radiating element at a distance to its feeding point shorter than a quarter, or longer than three quarters, of the external perimeter of the radiating element.

21.- An antenna according to any of the preceding claims characterised in that at least one of the holes is shaped as a curve, said curve intersecting itself at least at one point.

22.- An antenna according to any of the preceding claims characterised in that is an aperture antenna wherein the shape of its aperture is the same as any of the shapes of the radiating elements of the antennas described in the preceding claims.

23.- An antenna according to any of the preceding claims characterised in that the antenna is included as a radiating element within an antenna array.

24.- An antenna according to any of the preceding claims, characterised in that the antenna features a multiband behaviour, a broadband behaviour or a combination of both.

25.- An antenna according to any one of the preceding claims characterised in that at least one of the operating bands of the antenna is broadband.

26.- An antenna according to any of the preceding claims characterised in that the radiating element is shorter than a quarter of the longest operating wavelength.

27.- An antenna according to any of the preceding claims characterised in that the radiating element is printed, etched or attached over a dielectric substrate.

28.- An antenna according to claim 27 characterised in that the dielectric substrate is part of a structure selected from the group: the window glass of a motor vehicle, the metallic structure of a motor vehicle, the structure of a handheld terminal.

29.- An antenna according to any one of the preceding claims characterised in that is used to transmit or receive electromagnetic waves for at least one of the following telecom systems: GSM900, GSM1800, GSM850, PCS1900, CDMA, WCDMA, TDMA, UMTS, Bluetooth™, IEEE802.11b, IEEE802.11g, IEEE802.11a, Ultra Wide Band (UWB).

30.- An antenna according to any one of the preceding claims characterised in that is used to transmit or receive electromagnetic waves simultaneously for at least three of the several telecom systems: GSM900, GSM1800, GSM850, PCS1900, CDMA, WCDMA, TDMA, UMTS, Bluetooth™, IEEE802.11b, IEEE802.11g, IEEE802.11a, Ultra Wide Band (UWB).
